(19) United States
(12) Patent Application Publication
(10) Pub. No.: US 2026/0081639 A1
(43) Pub. Date: Mar. 19, 2026

(54) INFORMATION TRANSCEIVING METHOD AND ASSOCIATED COMMUNICATION DEVICES

(71) Applicant: Realtek Semiconductor Corp., HsinChu (TW)

(72) Inventor: Yueh-Hsing Huang, HsinChu (TW)

(73) Assignee: Realtek Semiconductor Corp., HsinChu (TW)

(21) Appl. No.: 19/332,073

(22) Filed: Sep. 18, 2025

(30) Foreign Application Priority Data
Sep. 19, 2024 (TW) 113135537

(51) Int. Cl. H04B 1/40; H04L 65/756

(52) U.S. Cl. CPC H04B 1/40; H04L 65/756

(57) ABSTRACT

An information transceiving method is implemented by an information transceiving system including a transmitting device and multiple receiving devices, and includes: collecting, by the transmitting device, multiple requirements, wherein the multiple requirements at least include an output capability corresponding to each of the multiple receiving devices; determining, by the transmitting device, a transceiving specification according to the multiple requirements, wherein the transceiving specification is at least higher than a first output capability corresponding to a first receiving device among the multiple receiving devices; and transmitting, by the transmitting device, information to the multiple receiving devices according to the transceiving specification.

### BACKGROUND OF THE INVENTION

### 1. FIELD OF THE INVENTION

The present invention is related to information transceiving, and more particularly, to an information transceiving method and associated communication devices that can enable all receiving devices to achieve their optimal audiovisual and functional performance.

### 2. DESCRIPTION OF THE PRIOR ART

With advancements in video and audio technology, modern electronic devices are now capable of utilizing various advanced transceiving specifications to transmit or receive multi-media information, such as high definition multimedia interface (HDMI), universal serial bus (USB), and USB type-C (USB-C). In addition, enhanced functionalities such as audio return channel (ARC) and enhanced ARC (eARC) have begun to be supported by some electronic devices, enabling multi-media audiovisual applications to become increasingly diverse, resulting in the rapid development of related audiovisual integration technologies.

### SUMMARY OF THE INVENTION

It is therefore one of the objectives of the present invention to provide an information transceiving method that can make all receiving devices achieve their optimal audiovisual and functional performance, in order to address the above-mentioned issues.

According to an embodiment of the present invention, an information transceiving method is provided. The information transceiving method is implemented by an information transceiving system comprising a transmitting device and multiple receiving devices, and comprises: collecting, by the transmitting device, multiple requirements, wherein the multiple requirements at least comprise an output capability corresponding to each of the multiple receiving devices; determining, by the transmitting device, a transceiving specification according to the multiple requirements, wherein the transceiving specification is at least higher than a first output capability corresponding to a first receiving device among the multiple receiving devices; and transmitting, by the transmitting device, information to the multiple receiving devices according to the transceiving specification.

According to an embodiment of the present invention a communication device is provided. The communication device comprises a processor and a communication module. The processor is arranged to collect multiple requirements from multiple receiving devices in an information transceiving system, and determine a transceiving specification according to the multiple requirements, wherein the multiple requirements at least comprise an output capability corresponding to each of the multiple receiving devices. The communication module is arranged to transmit information to the multiple receiving devices according to the transceiving specification, wherein the transceiving specification is at least higher than a first output capability corresponding to a first receiving device among the multiple receiving devices.

According to an embodiment of the present invention a communication device is provided. The communication device comprises a processor, a communication module, and an information processing engine. The processor is arranged to determine an output capability according to a signal processing capability of a peripheral device, and provide the output capability to a transmitting device for acting as a requirement. The communication module is arranged to receive information from the transmitting device, wherein a transceiving specification of the information is higher than the output capability. The information processing engine is arranged to down-convert the information according to the output capability in order to generate down-converted information, and provide the down-converted information to the peripheral device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an information transceiving system according to an embodiment of the present invention.

FIG. 2 is a flow chart of an information transceiving method according to an embodiment of the present invention.

FIG. 3 is a block diagram of a transmitting device according to an embodiment of the present invention.

FIG. 4 is a flow chart of operations of a transmitting device during a process of information transceiving according to an embodiment of the present invention.

FIG. 5 is a block diagram illustrating a receiving device according to an embodiment of the present invention.

FIG. 6 is a flow chart of operations of a receiving device during a process of information transceiving according to an embodiment of the present invention.

FIG. 7 is a diagram illustrating a many-to-many information transceiving system according to an embodiment of the present invention.

FIG. 8 is a diagram illustrating an information transceiving system according to another embodiment of the present invention.

FIG. 9 is a diagram illustrating an information transceiving system according to another embodiment of the present invention.

### DETAILED DESCRIPTION

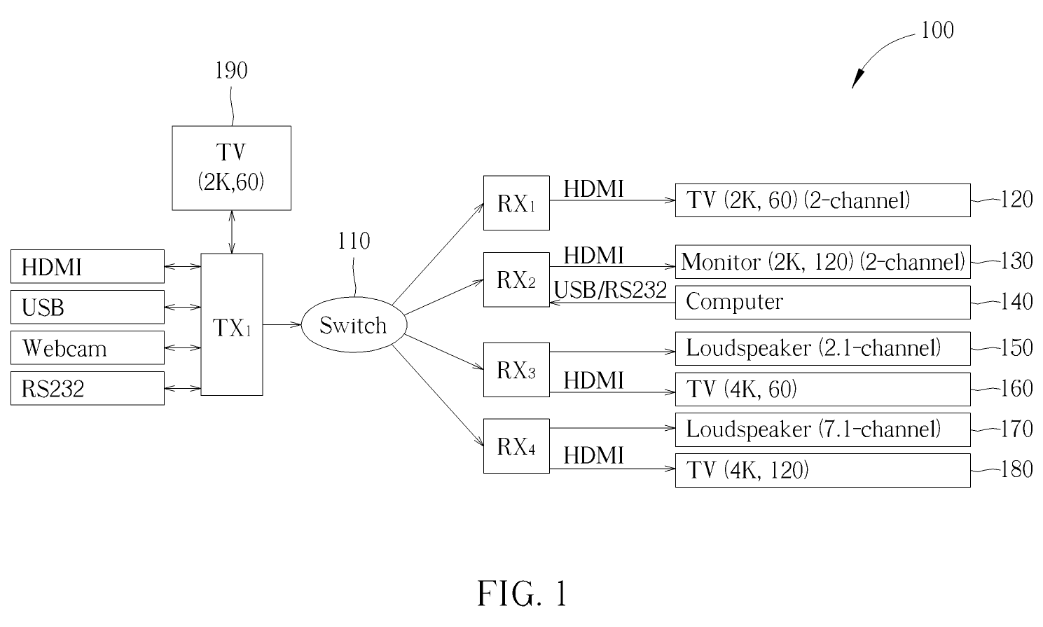

FIG. 1 is a diagram illustrating an information transceiving system 100 according to an embodiment of the present invention. The information transceiving system 100 may include at least one transmitting device TX₁ and multiple receiving devices, such as receiving devices RX₁ – RX₄. In an embodiment, the transmitting device TX₁ and each of the receiving devices RX₁ – RX₄ may be implemented as a communication device. An intranet may be established in the information transceiving system 100, and information may be transceived via a switch 110, wherein the switch 110 may be a network switch or a router, and the transmitting device TX₁ and the receiving devices RX₁ – RX₄ may transceive information via the switch 110 by either wired or wireless means.

In an embodiment, the at least one transmitting device TX₁ is an information providing side, and is arranged to provide information to the receiving devices RX₁ – RX₄ in a one-to-many manner.

In general, the capabilities of receiving devices vary. When a transmitting device is required to provide the same information to multiple receiving devices within an information transceiving system, the transmitting device typically outputs information based on the intersection of the capabilities of all receiving devices in order to prevent any receiving device from being unable to play back the received information. As a result, the transmission specification is determined based on the lowest specification, and receiving devices with higher capabilities are unable to achieve optimal audiovisual and functional performance.

In order to provide users with the optimal audiovisual and functional experience, according to an embodiment of the present invention, the transmitting device TX₁ outputs information by an optimal-service-first approach, wherein the information may include contents such as image signals, audio signals, or functions provided by the transmission device TX₁.

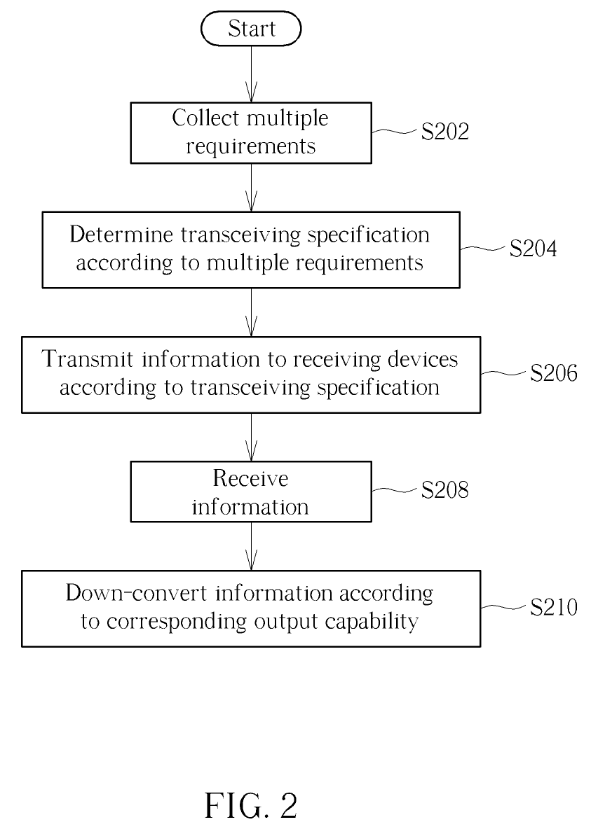

FIG. 2 is a flow chart of an information transceiving method according to an embodiment of the present invention, wherein the information transceiving method is implemented by an information transceiving system including at least one transmitting device and multiple receiving devices.

In Step S202, multiple requirements are collected. According to an embodiment of the present invention, the multiple requirements at least include an output capability corresponding to each of the multiple receiving devices. In some embodiments, the requirements collected by the transmitting device may further include an output capability corresponding to the transmitting device.

In Step S204, a transceiving specification is determined according to the multiple requirements. According to an embodiment of the present invention, an optimal-service-first approach is adopted for determining the transceiving specification, wherein the term “optimal service” may refer to various criteria, such as the highest specification, a specification supported by the largest number of receiving devices, the highest specification that is supported by all devices in terms of information processing capability, or the most diversified set of services. As a result, when the receiving devices have different output capabilities, the determined transceiving specification may be higher than the output capability of at least one receiving device.

In Step S206, information is transmitted to the receiving devices according to the transceiving specification.

In Step S208, the information is received.

In Step S210, the information is down-converted according to a corresponding output capability.

In this embodiment, Steps S202 – S206 are executed by the transmitting device, and Step S208 is executed by the receiving devices. Step S210 is an optional step, and can be executed by a device with a worse output capability. For example, when a transceiving specification determined in Step S204 is higher than an output capability corresponding to a device, the device can execute Step S210, and may be either a transmitting device or a receiving device.

Take FIG. 1 as an example. Each of the receiving devices RX₁ – RX₄ is coupled to one or more ancillary devices or peripheral devices. For example, the receiving device RX₁ is coupled to a television (TV) 120. The receiving device RX₂ is coupled to a monitor 130 and a computer 140. The receiving device RX₃ is coupled to a loudspeaker 150 and a TV 160. The receiving device RX₄ is coupled to a loudspeaker 170 and a TV 180. Similarly, the transmitting device TX₁ may be coupled to one or more ancillary devices or peripheral devices. For example, the transmitting device TX₁ is coupled to a TV 190. These ancillary devices or peripheral devices may receive information from the receiving devices RX₁ – RX₄ or the transmitting device TX₁, and present contents of the information through their respective interfaces or components. Therefore, these ancillary devices or peripheral devices may be regarded as downstream devices of the receiving devices RX₁ - RX₄ or the transmitting device TX₁.

In this embodiment, the downstream devices have different capabilities. For example, the TV 120 supports a signal format of 2K resolution and a frame rate of 60 frames per second (FPS). The monitor 130 supports a signal format of 2K resolution and a frame rate of 120 FPS. The loudspeaker 150 is a 2.1-channel loudspeaker. The TV 160 supports a signal format of 4K resolution and a frame rate of 60 FPS. The loudspeaker 170 is a 7.1-channel loudspeaker. The TV 180 supports a signal format of 4K resolution and a frame rate of 120 FPS. The TV 190 supports a signal format of 2K resolution and a frame rate of 60 FPS. For better comprehension, the capabilities of the downstream devices are briefly indicated within corresponding components in FIG. 1. For example, a notation “(2K, 60)” shown in the TV 120 indicates that the TV 120 is capable of supporting a signal format of 2K resolution and a frame rate of 60 FPS.

According to an embodiment of the present invention, the transmitting device TX₁ may collect multiple requirements of the receiving devices RX₁ – RX₄, wherein the multiple requirements at least include an output capability corresponding to each of the receiving devices RX₁ – RX₄. For example, in response to the TV 120 being capable of supporting a signal format of (2K, 60), the receiving device RX₁ may set a corresponding output capability requirement as (2K, 60), and provide the output capability requirement to the transmitting device TX₁.

Similarly, in response to the monitor 130 being equipped with an HDMI interface and being capable of supporting a signal format of (2K, 120), the receiving device RX₂ may provide an output capability requirement of (2K, 120) to the transmitting device TX₁. In response to the TV 160 being equipped with an HDMI interface and being capable of supporting a signal format of (4K, 60), and the loudspeaker 150 being a 2.1-channel loudspeaker, the receiving device RX₃ may provide an output capability requirement of (4K, 60) and 2.1-channel to the transmitting device TX₁. In response to the TV 180 being equipped with an HDMI interface and being capable of supporting a signal format of (4K, 120), and the loudspeaker 170 being a 7.1-channel loudspeaker, the receiving device RX₄ may provide an output capability requirement of (4K, 120) and 7.1-channel to the transmitting device TX₁.

In addition, since the downstream devices of the receiving device RX₂ further include the computer 140, and the computer 140 is capable of controlling one or more serial data communication interfaces different from the HDMI interface (e.g., a USB interface or an RS232 interface), the receiving device RX₂ may also regard the control capability of other communication interfaces as an ancillary service requirement for providing to the transmitting device TX₁. For example, other communication interfaces may refer to communication interfaces other than HDMI.

After collecting requirements from the receiving devices RX₁ – RX₄, the transmitting device TX₁ may determine a transceiving specification by an optimal-service-first approach, and transmit information to the receiving devices RX₁ – RX₄ according to the determined transceiving specification.

According to an embodiment of the present invention, the transmitted information may be an image signal, and the output capability of the receiving device may include at least one of an image resolution, a frame rate, an image brightness or contrast dynamic range, and a frame rate updating capability. According to another embodiment of the present invention, the transmitted information may be an audio signal, and the output capability of the receiving device may include at least one of a sampling rate, a number of stereo channels, an audio return channel (ARC) supporting capability, an enhanced audio return channel (eARC) supporting capability, and a high-fidelity (Hi-Fi) transmission interface supporting capability.

In an embodiment of the present invention, the output capability requirement of each receiving device may correspond to a specification, and the transmitting device TX₁ may select the highest specification or a specification supported by the largest number of receiving devices from the multiple specifications, for acting as the transceiving specification. For example, the transmission device TX₁ may take the union of the specifications corresponding to the receiving devices RX₁ - RX₄, and select the highest specification as the transceiving specification.

In another embodiment of the present invention, the transmitting device TX₁ may select a specification with the optimal service quality as the transceiving specification, wherein the specification with the optimal service quality may be the highest specification among one or more specifications, and the receiving devices RX₁ - RX₄ are capable of down-converting the one or more specifications.

As a result, when the receiving devices are equipped with different output capabilities, the transceiving specification determined by the transmitting device TX₁ may be higher than at least one output capability corresponding to at least one receiving device.

In some embodiments, when the transmitting device TX₁ determines or selects the transceiving specification, an output capability corresponding to the transmitting device TX₁ may also be taken into consideration. For example, the transmitting device TX₁ may take the union of the specifications corresponding to the receiving devices RX₁ - RX₄ and the transmitting device TX₁, and select the highest specification or a specification supported by the largest number of devices as the transceiving specification. In another example, the transmitting device TX₁ may select a specification with the optimal service quality from the specifications corresponding to the receiving devices RX₁ - RX₄ and the transmitting device TX₁ for acting as the transceiving specification, wherein the specification with the optimal service quality may be the highest specification among one or more specifications, and the each of the receiving devices RX₁ - RX₄ and the transmitting device TX₁ is capable of down-converting the one or more specifications.

As shown in FIG. 1, for an image signal, a specification union between the transmitting device TX₁ and the receiving devices RX₁ – RX₄ includes 2K resolution, 4K resolution and frame rates of 60 FPS and 120 FPS, and the transmitting device TX₁ may select the highest specification (4K, 120) as the transceiving specification. In addition, for the number of stereo channels, the specification union between the receiving devices RX₁ – RX₄ includes 2-channel, 2.1-channel, and 7.1-channel, and the transmitting device TX₁ may select the highest specification 7.1-channel as the transceiving specification.

The transmitting device TX₁ may notify an information source of the determined transceiving specification (4K, 120) and 7.1-channel. For example, an external image/audio signal (hereinafter referred to as an audiovisual signal) source may be coupled to the transmitting device TX₁ via an HDMI interface. The information source may provide information according to the transceiving specification, and the transmitting device TX₁ may receive the information from the information source according to the transceiving specification. In other words, the transmitting device TX₁ may receive information related to the specification with the optimal service quality from the information source.

After obtaining the information, the transmitting device TX₁ may transmit the same information to the receiving devices RX₁ – RX₄ according to the transceiving specification of (4K, 120) and 7.1-channel. After receiving the information, each of the receiving devices RX₁ – RX₄ may determine whether to down-convert the received information according to a corresponding capability.

For example, since the output capability requirement of the receiving device RX₁ is (2K, 60), the receiving device RX₁ may down-convert the information of (4K, 120) into a signal of 2K resolution and 60 FPS for providing to the downstream devices. In addition, since the TV 120 is equipped with a fundamental 2-channel, the receiving device RX₁ may down-convert an audio signal of 7.1-channel into an audio signal of 2-channel for providing to the downstream devices. Similarly, since the output capability requirement of the receiving device RX₂ is (2K, 120), the receiving device RX₂ may down-convert the information of (4K, 120) into a signal of 2K resolution for providing to the downstream devices. In addition, since the monitor 130 is equipped with a fundamental 2-channel, the receiving device RX₂ may down-convert the audio signal of 7.1-channel into an audio signal of 2-channel for providing to the downstream devices. Since the output capability requirement of the receiving device RX₃ is (4K, 60), the receiving device RX₃ may down-convert the information of (4K, 120) into a signal of 60 FPS for providing to the downstream devices. In addition, the receiving device RX₃ may down-convert the audio signal of 7.1-channel into an audio signal of 2.1-channel for providing to the downstream devices.

For the receiving device RX₄, since the output capability requirement of the receiving device RX₄ is (4K, 120) and 7.1-channel, the receiving device RX₄ may directly provide the received information to the downstream devices without performing any information format down-conversion.

For the transmitting device TX₁, the received information may also be provided to the downstream devices, and the transmitting device TX₁ may determine whether to perform the information format down-conversion based on the format supported by the downstream devices. For example, the transmitting device TX₁ may down-convert the information of (4K, 120) into a signal of 2K resolution and 60 FPS for providing to the downstream devices.

In addition, the transmitting device TX₁ may enable a corresponding interface according to an ancillary service requirement from a receiving device, and transceive ancillary information between the receiving device and the interface, or between the receiving device and an ancillary device coupled to the transmitting device TX₁ via the interface.

As shown in FIG. 1, in addition to an HDMI interface, the transmitting device TX₁ further includes other communication interfaces, such as a USB interface and an RS232 interface. The transmitting device TX₁ may be coupled to a USB or a webcam via the USB interface. The receiving device RX₂ may transmit a requirement for accessing the USB or controlling the webcam (i.e., the ancillary service requirement). In response to the ancillary service requirement from the receiving device RX₂, the transmitting device TX₁ may correspondingly enable the USB interface or the RX232 interface.

In addition, the transmitting device TX₁ may be further arranged to receive a control signal corresponding to the USB interface or the RS232 interface from the receiving device RX₂, and transmit the control signal to the USB interface or the RS232 interface in order to further control ancillary devices coupled to the transmitting device TX₁ via the USB interface or the RS232 interface, wherein the control signal corresponding to the USB interface or the RS232 interface and information transceived between the receiving device and the USB/RS232 interface may be regarded as the above-mentioned ancillary information. By this service, the receiving device RX₂ may access or control ancillary devices coupled to the transmitting device TX₁, such as the USB and the webcam.

In an embodiment of the present invention, the transmitting device TX₁ may receive requirements from the receiving devices RX₁ – RX₄ via a network interface, receive information from the information source via an HDMI interface, and provide the information to the receiving devices RX₁ – RX₄ via the network interface. In addition, the transmitting device TX₁ may receive ancillary service requirements from the receiving devices RX₁ – RX₄ via the network interface, and forward control signals from the receiving devices RX₁ – RX₄ via communication interfaces. Alternatively, the transmitting device TX₁ may receive information provided by the ancillary devices via the communication interfaces, and forward the information to the receiving devices RX₁ – RX₄ via the network interface.

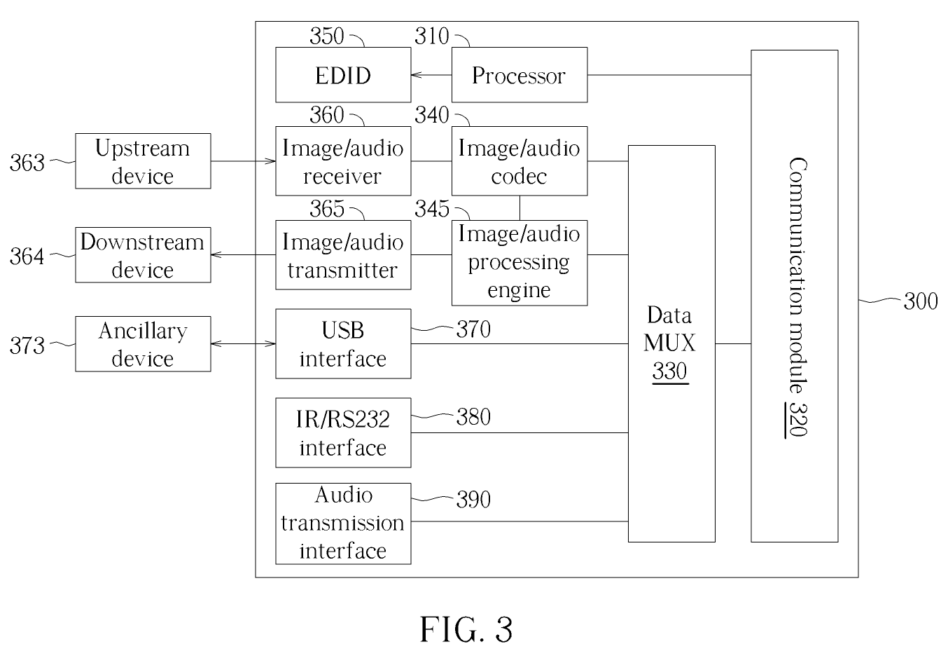

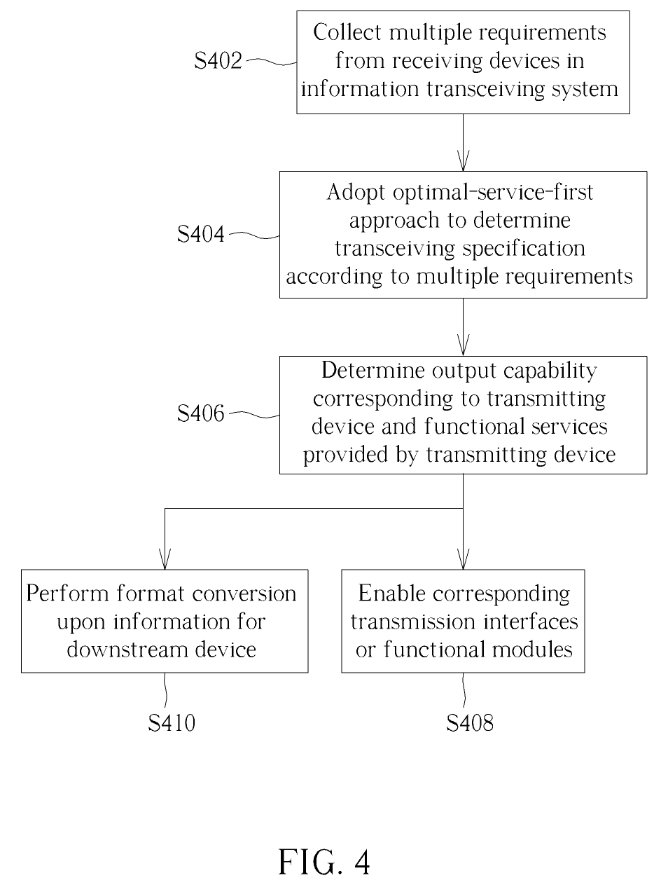

FIG. 3 is a block diagram of a transmitting device 300 according to an embodiment of the present invention. FIG. 4 is a flow chart of operations of the transmitting device 300 during a process of information transceiving according to an embodiment of the present invention.

The transmitting device 300 may be a communication device, and may include a processor 310, a communication module 320, and a data multiplexer (MUX) 330. The processor 310 may establish an intranet with receiving devices in an information transceiving system via the communication module 320. The communication module 320 may be an Ethernet module, and may include a communication interface, wherein the communication module 320 may communicate with a switch within the information transceiving system (e.g., the switch 110 shown in FIG. 1) via the communication interface. During a process of establishing the intranet, the transmitting device 300 may perform a handshake procedure with the receiving devices in order to exchange messages or perform identity confirmation.

After the intranet is established, the processor 310 may collect multiple requirements from the receiving devices in the information transceiving system (Step S402 of FIG. 4), and adopt an optimal-service-first approach to determine a transceiving specification according to the multiple requirements (Step S404 of FIG. 4).

As mentioned above, the multiple requirements may at least include an output capability corresponding to each receiving device. In some embodiments, the multiple requirements may further include ancillary service requirements sent from the receiving devices.

Afterwards, the processor 310 may determine an output capability corresponding to the transmitting device 300 and functional services provided by the transmitting device 300 (Step S406 of FIG. 4).

Specifically, the transmitting device 300 may further include an image/audio codec 340, an image/audio processing engine 345, an extended display identification data (EDID) 350, an image/audio receiver 360, an image/audio transmitter 365, a USB interface 370, an infrared (IR) control and/or RS232 interface 380 (labeled as “IR/RS232 interface” in FIG. 3), and an audio transmission interface 390.

The EDID 350 may include associated information of a display device, including an image resolution and a signal format supported by the display device.

The image/audio receiver 360 may be an HDMI and/or display port (DP) receiver including an HDMI/DP receiving port, and may be arranged to receive an audiovisual signal from an upstream device 363 (e.g., an external audiovisual signal source).

The image/audio transmitter 365 may be an HDMI and/or DP transmitter including an HDMI/DP transmitting port, and may be arranged to transmit an audiovisual signal to a downstream device 364 (e.g., an external display device).

In addition, an external device (e.g., a USB, a webcam, a keyboard, a mouse, a loudspeaker, and a microphone) may be coupled to the transmitting device 300 via the USB interface 370, for acting as an ancillary device 373.

The IR/RS232 interface 380 may include an IR transmitter, an IR receiver, and/or an RS232 transmission interface, for providing a bidirectional transceiving function of an IR control signal and/or an RS232 control signal.

The audio transmission interface 390 may be a Hi-Fi transmission interface, such as a Sony/Philips digital interface format (SPDIF) and an audio transmission interface equipped with an ARC/eARC function.

The data MUX 330 may be coupled to the image/audio codec 340, the image/audio processing engine 345, the image/audio receiver 360, the image/audio transmitter 365, the USB interface 370, the IR/RS232 interface 380, and the audio transmission interface 390, and may be arranged to perform a multiplexing operation and a de-multiplexing operation upon data between multiple transmission interfaces and the communication module 320.

In an embodiment of the present invention, the functional services for the receiving devices provided by the transmitting device 300 may include device control or data retrieval of the webcam, the unidirectional or bidirectional IR transceiving, and the RS232.

It should be noted that, due to the wide variety of transmission interfaces, functional services, and peripheral devices that modern electronic devices or communication devices can support or be equipped with, the descriptions and illustrations disclosed herein are simplified and only partially exemplify some aspects for brevity. Those skilled in the art will understand that the information transmission interfaces and functional services to which the present invention may be applied are not limited to the contents disclosed in this specification. Therefore, the present invention is not limited to the examples mentioned above.

After determining an output capability corresponding to the transmitting device 300 and functional services provided by the transmitting device 300, the processor 310 may enable corresponding transmission interfaces or functional modules according to output capability requirements of the receiving devices and the transmitting device 300 and ancillary service requirements sent by the receiving devices (Step S408 of FIG. 4).

For example, the processor 310 may write a required audiovisual signal transceiving specification into a corresponding memory space for acting as the EDID 350. The upstream device 363 may obtain a transceiving specification required by the transmitting device 300 according to contents of the EDID 350, and output a corresponding audiovisual signal (e.g., an HDMI signal) to the image/audio receiver 360 according to the transceiving specification.

In another example, the processor 310 may correspondingly enable the USB interface 370, the IR/RS232 interface 380, or a functional module in response to an ancillary service requirement from a receiving device (e.g., a requirement of accessing a USB or controlling a webcam).

According to an embodiment of the present invention, the image/audio receiver 360 may receive corresponding information (e.g., an audiovisual signal) from the upstream device 363 according to the determined transceiving specification, and provide the audiovisual signal to the communication module 320 via the image/audio codec 340 and the data MUX 330. The communication module 320 may transmit the audiovisual signal to the receiving devices according to the determined transceiving specification.

In addition, the transmitting device 300 may provide a received audiovisual signal to the downstream device 364, and determine whether to down-convert a format of the audiovisual signal according to a format supported by the downstream device 364. For example, the audiovisual signal may be provided to the image/audio processing engine 345 for performing format conversion upon the audiovisual signal (Step S410 of FIG. 4). If the format conversion is not required, the image/audio processing engine 345 may perform required processing upon the audiovisual signal for providing to the downstream device 364.

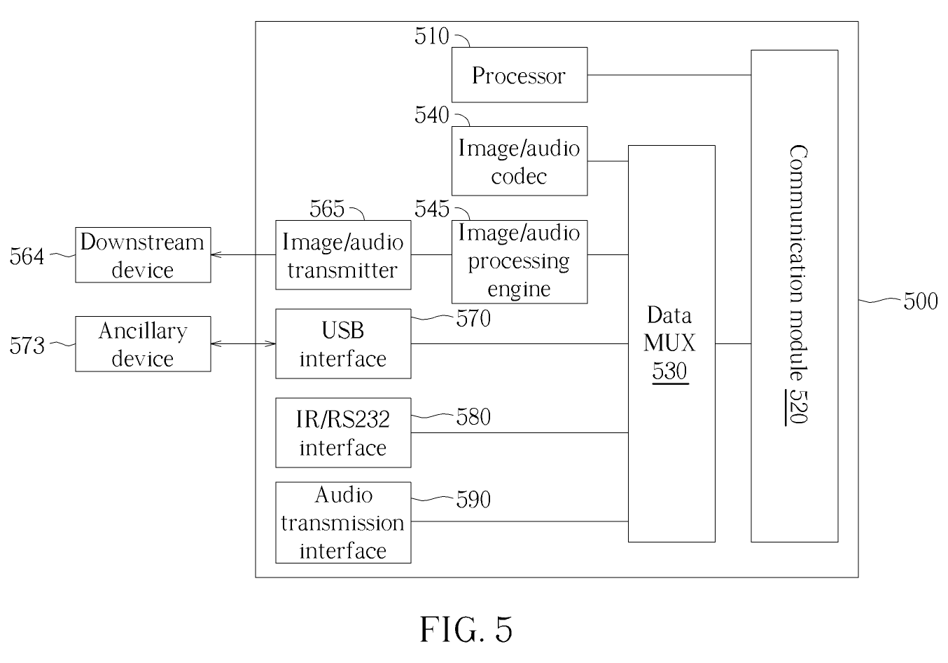

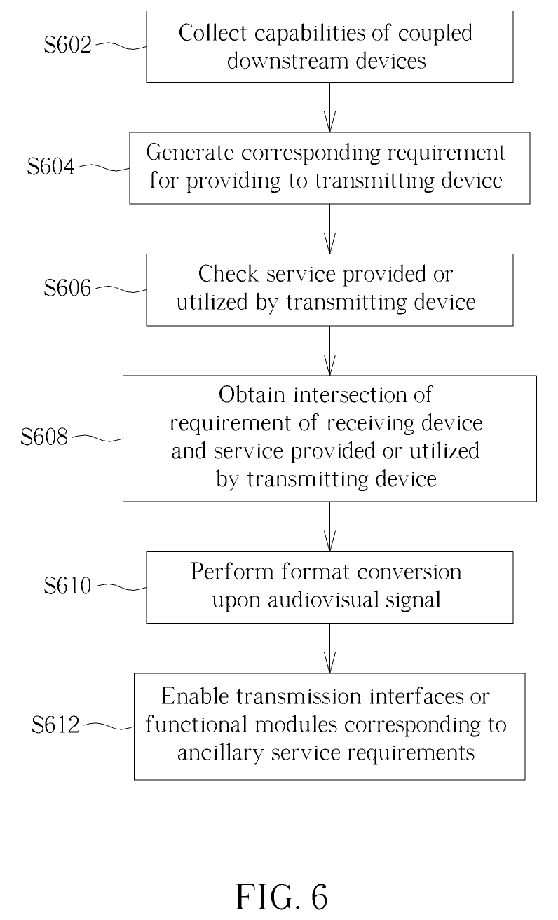

FIG. 5 is a block diagram illustrating a receiving device 500 according to an embodiment of the present invention. FIG. 6 is a flow chart of operations of the receiving device 500 during a process of information transceiving according to an embodiment of the present invention.

The receiving device 500 may be a communication device, and may include a processor 510, a communication module 520, and a data MUX 530. The processor 510 may establish an intranet with a transmitting device in an information transceiving system via the communication module 520. The communication module 520 may be an Ethernet module, and may include a communication interface, wherein the communication module 520 may communicate with a switch within the information transceiving system (e.g., the switch 110 shown in FIG. 1) via the communication interface. During a process of establishing the intranet, the receiving device 500 may perform a handshake procedure with the transmitting device in order to exchange messages or perform identity confirmation.

After the intranet is established, the processor 510 may collect capabilities (e.g., signal processing capabilities) of all coupled downstream devices (Step S602 of FIG. 6), and generate corresponding requirements according to the collected capabilities for providing to the transmitting device (Step S604 of FIG. 6).

In an embodiment of the present invention, the processor 510 may determine an output capability of a receiving device according to the signal processing capabilities of the downstream devices, and set the output capability as a requirement for providing to the transmitting device. In some embodiments, the processor 510 may determine an ancillary service requirement according to the signal processing capabilities of the downstream devices, for acting as a requirement provided to the transmitting device.

In some embodiments, when information related to service contents that can be provided or utilized by the transmitting device is obtained, the processor 510 may check the service provided or utilized by the transmitting device (Step S606 of FIG. 6), and obtain the intersection of the requirement of the receiving device 500 and the service provided or utilized by the transmitting device (Step S608 of FIG. 6) in order to determine whether the service provided or utilized by the transmitting device is required by the receiving device 500.

In this embodiment, the information transceiving system includes a transmitting device that provides information to the receiving devices in a one-to-many manner, but the present invention is not limited thereto. In some embodiments, the information transceiving system may include multiple transmitting devices that provide information to the receiving devices in a many-to-many manner.

As shown in FIG. 5, the receiving device 500 may further include an image/audio codec 540, an image/audio processing engine 545, an image/audio transmitter 565, a USB interface 570, an IR/RS232 interface 580, and an audio transmission interface 590.

The image/audio transmitter 565 may be an HDMI/DP transmitter including an HDMI/DP transmission port, and may be arranged to transmit an audiovisual signal to a downstream device 564 (e.g., an external display device).

In addition, an external device (e.g., a USB, a webcam, a keyboard, a mouse, a loudspeaker, and a microphone) may be coupled to the receiving device 500 via the USB interface 570, for acting as an ancillary device 573.

The IR/RS232 interface 580 may include an IR transmitter, an IR receiver, and/or an RS232 transmission interface, for providing a bidirectional transceiving function of an IR control signal and/or an RS232 control signal.

The audio transmission interface 590 may be a Hi-Fi transmission interface, such as an SPDIF and an audio transmission interface equipped with an ARC/eARC function.

The data MUX 530 may be coupled to the image/audio codec 540, the image/audio processing engine 545, the image/audio transmitter 565, the USB interface 570, the IR/RS232 interface 580, and the audio transmission interface 590, and may be arranged to perform a multiplexing operation and a de-multiplexing operation upon data between multiple transmission interfaces and the communication module 520.

In an embodiment of the present invention, the ancillary services required by the receiving device 500 may include controlling a webcam of a transmitting device via a coupled computer, accessing a USB, or uni-directionally or bi-directionally transceiving an IR signal or an RS232 control signal via a transmitting device.

It should be noted that, due to the wide variety of transmission interfaces, functional services, and peripheral devices that modern electronic devices or communication devices can support or be equipped with, the descriptions and illustrations disclosed herein are simplified and only partially exemplify some aspects for brevity. Those skilled in the art will understand that the information transmission interfaces and functional services to which the present invention may be applied are not limited to the contents disclosed in this specification. Therefore, the present invention is not limited to the examples mentioned above.

According to an embodiment of the present invention, a transmitting device may transmit an audiovisual signal to the receiving device 500 according to a determined transceiving specification. After receiving the audiovisual signal, the receiving device 500 may determine whether to down-convert a format of the audiovisual signal according to an output capability of the receiving device 500 (e.g., the format supported by the downstream device 564). For example, the audiovisual signal may be provided to the image/audio processing engine 545 for performing format conversion according to the output capability of the receiving device 500 (Step S610 of FIG. 6). If the format conversion is not required, the image/audio processing engine 545 may perform required processing upon the audiovisual signal for providing to the downstream device 564.

In addition, the processor 510 may enable transmission interfaces or functional modules corresponding to ancillary service requirements (Step S612 of FIG. 6) in order to utilize functional services provided by the transmitting device or access/control ancillary devices coupled to the transmitting device.

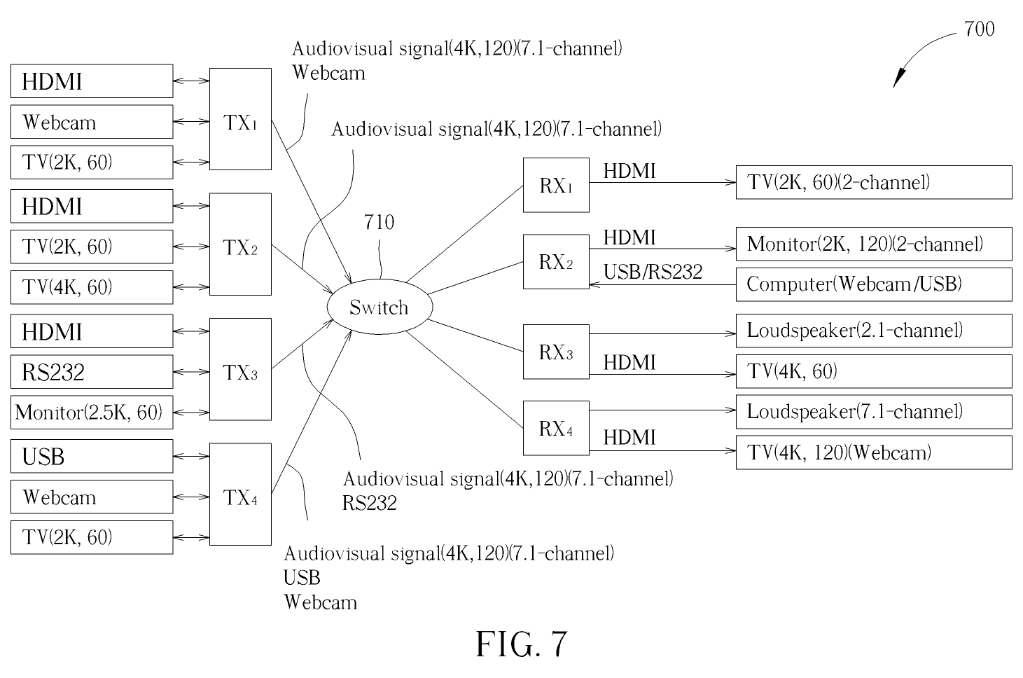

FIG. 7 is a diagram illustrating a many-to-many information transceiving system 700 according to an embodiment of the present invention. The many-to-many information transceiving system 700 may include multiple transmitting devices TX₁ – TX₄ and multiple receiving devices RX₁ – RX₄. Each of the transmitting devices TX₁ – TX₄ and each of the receiving devices RX₁ – RX₄ may be implemented as a communication device. An intranet may be established in the many-to-many information transceiving system 700, and information may be transceived via a switch 710, wherein the switch 710 may be a network switch or a router, and the transmitting devices TX₁ – TX₄ and the receiving devices RX₁ – RX₄ may transceive information via the switch 710 by either wired or wireless means.

For better comprehension, the capabilities of downstream devices or ancillary devices coupled to each transmitting device and each receiving device are briefly indicated within corresponding components in FIG. 7. For example, the transmitting device TX₁ may include an HDMI interface, and may be coupled to a webcam and a TV supporting a signal format of 2K resolution and a frame rate of 60 FPS (labeled as a notation “(2K, 60)” in FIG. 7). The transmitting device TX₂ may include an HDMI interface, and may be coupled to a TV supporting a signal format of (2K, 60) and a TV supporting a signal format of (4K, 60). The transmitting device TX₃ may include an HDMI interface, and may be coupled to a monitor supporting a signal format of (2.5K, 60). The transmitting device TX₄ may include a USB interface, and may be coupled to a webcam, a USB, and a TV supporting a signal format of (2K, 60).

The receiving device RX₁ may be coupled to a TV supporting a signal format of (2K, 60) and 2-channel. The receiving device RX₂ may be coupled to a computer and a monitor supporting a signal format of (2K, 120) and 2-channel, wherein the computer may include a USB interface for being coupled to a webcam and a USB. The receiving device RX₃ may be coupled to a 2.1-channel loudspeaker and a TV supporting a signal format of (4K, 60). The receiving device RX₄ may be coupled to a 7.1-channel loudspeaker and a TV supporting a signal format of (4K, 120), wherein the TV may be coupled to a webcam.

Assume that each device has a processing capability of an audiovisual signal with the highest specification (4K, 120) and 7.1-channel. The transmitting devices TX₁ – TX₄ may determine the highest specification (4K, 120) and 7.1-channel as a transceiving specification, and transmit information to the receiving devices RX₁ – RX₄ according to the transceiving specification. Each of the receiving devices RX₁ – RX₄ may determine whether to down-convert the information according to a corresponding output capability.

Due to a coupled webcam, each of the transmitting devices TX₁ and TX₄ may further provide control of the webcam to a receiving device for acting as an ancillary service. In addition, since the transmitting device TX₄ is further coupled to a USB, the transmitting device TX₄ may provide an access right of the USB to a receiving device. Similarly, since the transmitting device TX₃ has an RS232 interface, the transmitting device TX₃ may provide control of the RS232 to a receiving device for acting as an ancillary service.

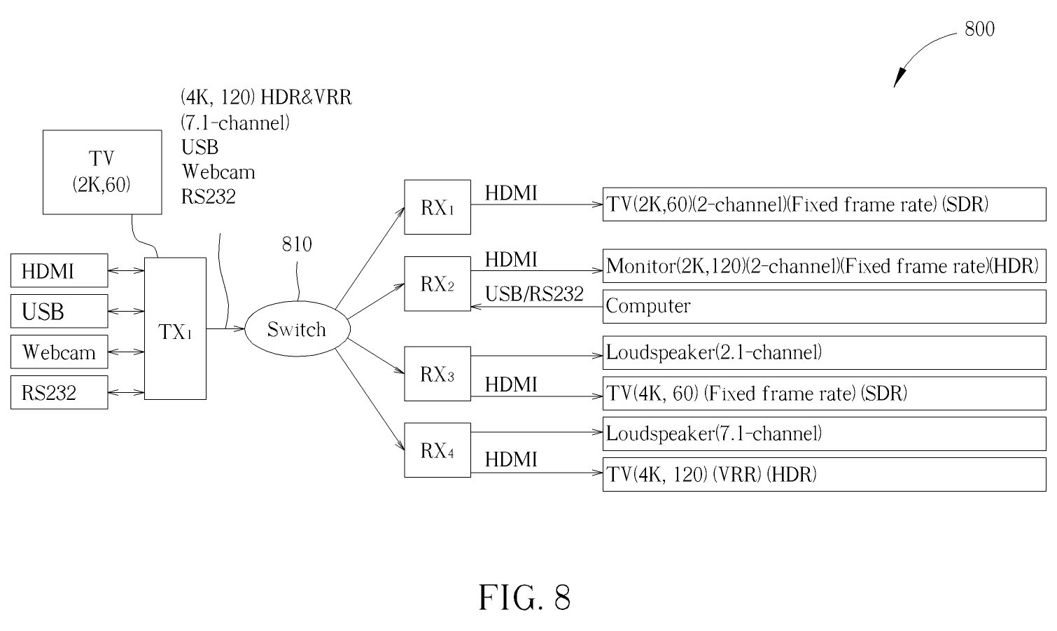

FIG. 8 is a diagram illustrating an information transceiving system 800 according to another embodiment of the present invention. The information transceiving system 800 may include at least one transmitting device TX₁ and multiple receiving devices RX₁ – RX₄. The transmitting device TX₁ may be coupled to a TV supporting a signal format of (2K, 60), and may include an HDMI interface, a USB interface, and an RS232 interface. The transmitting device TX₁ may be coupled to a USB and a webcam via the USB interface.

The ancillary devices and peripheral devices coupled to each of the receiving devices RX₁ – RX₄ in FIG. 8 are similar to those shown in FIG. 1. The output capability of each receiving device may further include a contrast dynamic range and a frame rate updating capability. Specifically, some peripheral devices in the information transceiving system 800 may support higher level functions. For example, some TVs or monitors may support a high dynamic range imaging (HDRI or HDR), an image brightness or contrast dynamic range, and/or a variable refresh rate (VRR) of a frame rate. With respect to HDR and VRR, the capabilities of other peripheral devices may be a standard dynamic range (SDR) and/or a fixed frame rate.

Assume that each device has a processing capability of an audiovisual signal with the highest format of (4K, 120), 7.1-channel, HDR, and VRR. The transmitting device TX₁ may determine the highest format as a transceiving specification, and transmit information to the receiving devices RX₁ – RX₄ according to the transceiving specification. Each of the receiving devices RX₁ – RX₄ may determine whether to down-convert the information according to a corresponding output capability.

For example, the receiving device RX₁ may down-convert the received signal into a signal of a fixed 60 FPS and SDR. The receiving device RX₂ may down-convert the received signal into a signal of a fixed 120 FPS. The receiving device RX₃ may down-convert the received signal into a signal of a fixed 60 FPS and SDR. Since the receiving device RX₄ has the highest output capability, the down-conversion is not required to be performed upon the received signal for the receiving device RX₄.

In addition, the transmitting device TX₁ has an RS232 interface and is coupled to a USB and a webcam. As a result, the transmitting device TX₁ may further provide control of the USB, the webcam, and the RS232 to a receiving device for acting as an ancillary service.

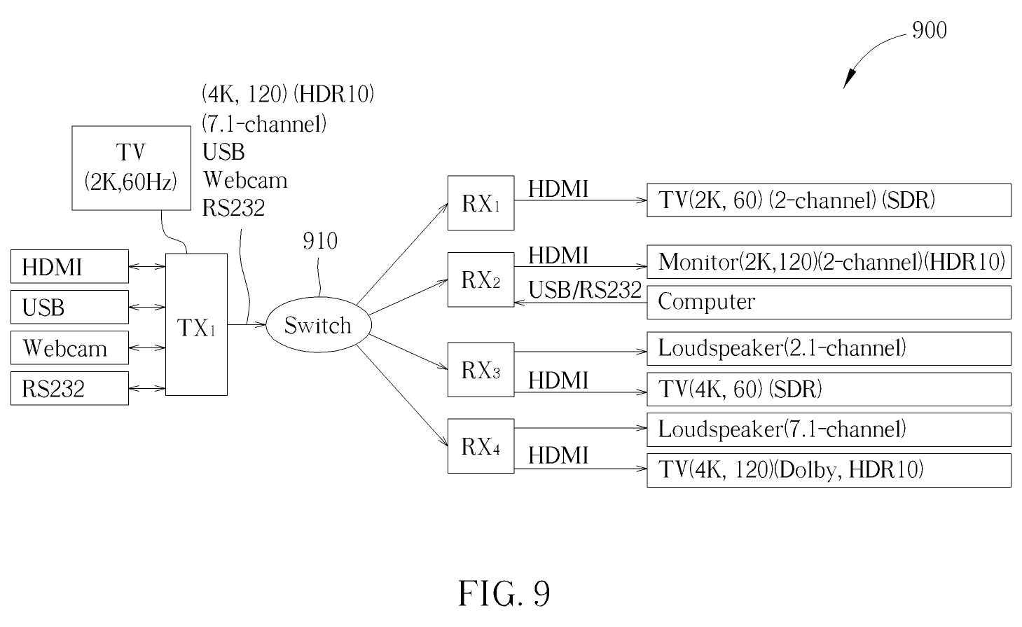

FIG. 9 is a diagram illustrating an information transceiving system 900 according to another embodiment of the present invention. The information transceiving system 900 may include at least one transmitting device TX₁ and multiple receiving devices RX₁ – RX₄. The transmitting device TX₁ may be coupled to a TV supporting a signal format of 2K resolution and 60 FPS, and may include an HDMI interface, a USB interface, and an RS232 interface. The transmitting device TX₁ may be coupled to a USB or a webcam via the USB interface.

The ancillary devices and peripheral devices coupled to each of the receiving devices RX₁ – RX₄ in FIG. 9 are similar to those in FIG. 1. Some peripheral devices in the information transceiving system 900 may support higher level functions. For example, a monitor coupled to the receiving device RX₂ may support HDR10, and a TV coupled to the receiving device RX₄ may support HDR10 and Dolby audio. With respect to HDR10, the capabilities of other peripheral devices may be SDR. In this embodiment, only the TV coupled to the receiving device RX₄ supports the Dolby audio, and other devices not supporting the Dolby audio are not able to down-convert the Dolby audio into other supportable specifications. As a result, each device has a processing capability of an audiovisual signal with the highest format of (4K, 120), 7.1-channel, and HDR10. The transmitting device TX₁ may determine the highest format as a transceiving specification, and transmit information to the receiving devices RX₁ – RX₄ according to the transceiving specification. Each of the receiving devices RX₁ – RX₄ may determine whether to down-convert the information according to a corresponding output capability.

For example, in terms of dynamic range imaging specifications, the receiving devices RX₁ and RX₃ may convert the received signal to an SDR signal. The receiving devices RX₂ and RX₄ support HDR10, and therefore are not required to perform down-conversion upon the received signal.

In addition to the Dolby audio, Dolby Vision HDR can also serve as another example of a similar concept. For instance, both the receiving devices RX₂ and RX₄ support the HDR10 (or HDR10+) format, but only the receiving device RX₄ supports Dolby Vision HDR. Dolby Vision HDR is a paid service and devices that do not support it are entirely incapable of performing format conversion upon a Dolby HDR signal. As a result, even though Dolby HDR represents the highest specification currently available in the information transceiving system, the transmitting device TX₁ cannot set Dolby HDR as the transceiving specification due to the lack of corresponding signal processing or down-conversion capabilities of the receiving devices RX₁ - RX₃.

Assume that each device has a processing capability of an audiovisual signal with the highest specification (4K, 120), 7.1-channel, HDR, HDR10, or HDR10+. The transmitting device TX₁ may determine the highest specification as a transceiving specification, and transmit information to the receiving devices RX₁ – RX₄ according to the transceiving specification. Each of the receiving devices RX₁ – RX₄ may determine whether to down-convert the information according to a corresponding output capability.

For example, the receiving device RX₁ may down-convert the received signal into a signal of 2-channel, 2K resolution, 60 FPS, and SDR. The receiving device RX₂ may down-convert the received signal into a signal of 2-channel, 2K resolution, 120 FPS, and HDR10. The receiving device RX₃ may down-convert the received signal into a signal of 2.1-channel, 4K resolution, 60 FPS, and SDR. Since the receiving device RX₄ has the highest output capability, the down-conversion is not required to be performed upon the received signal for the receiving device RX₄.

In addition, the transmitting device TX₁ has an RS232 interface and is coupled to a USB and a webcam. As a result, the transmitting device TX₁ may further provide control of the USB, the webcam, and the RS232 to a receiving device for acting as an ancillary service.

As mentioned above, when a receiving device receives a signal that exceeds its processing or supported output specification, the receiving device will not output the signal. Therefore, in order to prevent the receiving device from being unable to play the received information, the transmitting device typically outputs information based on the intersection of capabilities among the receiving devices. The transmission specification is finally chosen based on the lowest supported specification. Consequently, receiving devices with higher capabilities are unable to achieve the optimal audiovisual and functional performance.

In embodiments of the present invention, the transmitting device adopts an optimal-service-first approach for determining the transceiving specification. The term “optimal service” may refer to various criteria, such as the highest specification, a specification supported by the largest number of receiving devices, the highest specification that is supported by all devices in terms of information processing capability, or the most diversified set of services. AS a result, when the receiving devices have different output capabilities, the determined transceiving specification can be higher than at least one output capability corresponding to at least one receiving device. In this way, the traditional output limitations can be overcome and the optimal audiovisual and functional experience can be provided to users.

In summary, the information transceiving method and associated communication devices proposed by the present invention can make all receiving devices achieve the optimal audiovisual and functional performance, which can greatly improve the audiovisual and functional experience for the users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information transceiving method, implemented by an information transceiving system comprising a transmitting device and multiple receiving devices, comprising:
collecting, by the transmitting device, multiple requirements, wherein the multiple requirements at least comprise an output capability corresponding to each of the multiple receiving devices;
determining, by the transmitting device, a transceiving specification according to the multiple requirements, wherein the transceiving specification is at least higher than a first output capability corresponding to a first receiving device among the multiple receiving devices; and
transmitting, by the transmitting device, information to the multiple receiving devices according to the transceiving specification.

2. The information transceiving method of claim 1, wherein the information is an image signal, and the output capability comprises at least one of an image resolution, a frame rate, an image brightness or contrast dynamic range, and a frame rate updating capability.

3. The information transceiving method of claim 1, wherein the information is an audio signal, and the output capability comprises at least one of a sampling rate, a number of stereo channels, an audio return channel (ARC) supporting capability, an enhanced audio return channel (eARC) supporting capability, and a high-fidelity (Hi-Fi) transmission interface supporting capability.

4. The information transceiving method of claim 1, further comprising:
receiving, by the multiple receiving devices, the information; and
down-converting, by the first receiving device, the information according to the first output capability.

5. The information transceiving method of claim 1, wherein the multiple requirements further comprise an ancillary service requirement from a second receiving device among the multiple receiving devices, and the information transceiving method further comprises:
enabling, by the transmitting device, a first interface according to the ancillary service requirement; and
transceiving, by the transmitting device, ancillary information between the second receiving device and the first interface, or between the second receiving device and an ancillary device coupled to the transmitting device via the first interface.

6. The information transceiving method of claim 1, wherein the multiple requirements further comprise a second output capability corresponding to the transmitting device.

7. The information transceiving method of claim 1, further comprising:
notifying, by the transmitting device, an information source of the transceiving specification; and
receiving, by the transmitting device, the information from the information source according to the transceiving specification.

8. The information transceiving method of claim 7, further comprising:
down-converting, by the transmitting device, the information according to a second output capability corresponding to the transmitting device.

9. The information transceiving method of claim 1, wherein the output capability corresponds to a specification, and the step of determining, by the transmitting device, the transceiving specification according to the multiple requirements further comprises:
selecting a highest specification from multiple specifications corresponding to the multiple receiving devices, for acting as the transceiving specification.

10. The information transceiving method of claim 1, wherein the output capability corresponds to a specification, and the step of determining, by the transmitting device, the transceiving specification according to the multiple requirements further comprises:
selecting a specification with an optimal service quality from multiple specifications corresponding to the multiple receiving devices, wherein the specification with the optimal service quality is a highest specification among one or more specifications, and the multiple receiving devices are capable of down-converting the one or more specifications.

11. A communication device, comprising:
a processor, arranged to collect multiple requirements from multiple receiving devices in an information transceiving system, and determine a transceiving specification according to the multiple requirements, wherein the multiple requirements at least comprise an output capability corresponding to each of the multiple receiving devices; and
a communication module, arranged to transmit information to the multiple receiving devices according to the transceiving specification, wherein the transceiving specification is at least higher than a first output capability corresponding to a first receiving device among the multiple receiving devices.

12. The communication device of claim 11, wherein the information is an image signal, and the output capability comprises at least one of an image resolution, a frame rate, an image brightness or contrast dynamic range, and a frame rate updating capability.

13. The communication device of claim 11, wherein the information is an audio signal, and the output capability comprises at least one of a sampling rate, a number of stereo channels, an audio return channel (ARC) supporting capability, an enhanced audio return channel (eARC) supporting capability, and a high-fidelity (Hi-Fi) transmission interface supporting capability.

14. The communication device of claim 11, wherein the multiple requirements further comprise an ancillary service requirement from a second receiving device among the multiple receiving devices, and the processor is further arranged to enable a first interface according to the ancillary service requirement, and transceive ancillary information between the second receiving device and the first interface, or between the second receiving device and an ancillary device.

15. A communication device, comprising:
a processor, arranged to determine an output capability according to a signal processing capability of a peripheral device, and provide the output capability to a transmitting device for acting as a requirement;
a communication module, arranged to receive information from the transmitting device, wherein a transceiving specification of the information is higher than the output capability; and
an information processing engine, arranged to down-convert the information according to the output capability in order to generate a down-converted information, and provide the down-converted information to the peripheral device.
